(19) United States
(12) Patent Application Publication
(10) Pub. No.: US 2021/0246604 A1
(43) Pub. Date: Aug. 12, 2021

(54) LAUNDRY DEBRIS REMOVAL DEVICE AND METHOD OF USING SAME

(71) Applicant: Tobey Erhart, Ottawa, IL (US)

(72) Inventor: Tobey Erhart, Ottawa, IL (US)

(21) Appl. No.: 16/783,398

(22) Filed: Feb. 6, 2020

(51) Int. Cl. D06F 58/22; D06P 5/00

(52) U.S. Cl. CPC D06F 58/22; C08L 21/00; D06P 5/001

(57) ABSTRACT

A laundry debris removal device for use in a laundry air dryer that is made of a fabric base material and a tacky ink-based overlay substrate. The laundry debris removal device will be added to a load of laundry prior to drying and will tumble with the load. The device will gently abrade the exterior surface of the laundry, dislodging lint, hair, and other particulate laundry debris from the surface of the clothing. The laundry debris will then be released into the dryer's designed air flow and deposited into the dryer lint filter.

### BACKGROUND OF THE INVENTION

Attempting to remove lint and other debris from clothing during the drying process has existed since the development of commercial and personal washing and drying machines. Commonly, lint, dirt, hair, and other particular matter will cling to or be woven into fabrics as a result of the laundry process, creating an unattractive appearance for the user's clothing. In modern times, dryers have attempted to fix this lint issue by adding components onto the dryer drum to physically beat the fabric and, therefore, release the lint into the dryer airflow for capture in the dryer lint filter. One example in the textile art, the dryer baffle, was created for use as a physical obstacle that contacts and gently beats the drying laundry in the drum, resulting in the release of the laundry debris. The particulate matter would then disengage from the clothing into the dryer's air flow and be deposited onto the dryer lint filter. While this contacting technique is largely successful and will allow for some of the laundry debris to be relocated from the user's clothing into the lint filter, it is not unusual for most of the particulates to remain on the clothing. As such, there is still a long-felt need in the textile industry to develop a product that will remove lint in a more efficient and effective manner, without damaging the structural integrity of the user's clothing.

To that end, the present invention seeks to alleviate these concerns in the field of laundry debris removal. More particularly, the invention relates to a device used in a laundry dryer to capture laundry debris from drying articles of clothing and to release the laundry debris into the dryer airflow for capture by a dryer filter. Still more particularly, the present invention pertains to a plied sheet having an ink pattern printed on at least one surface of the plied sheet, wherein the ink pattern is made of a tackified ink that captures laundry debris, such as hair, fur, lint, and other particulates from articles being dried and releases the laundry debris into the dryer airflow for capture by the dryer lint filter.

It is, therefore, a primary object of the present invention to provide a laundry debris removal device that captures excess lint, human hair, animal fur, dust, and other particulate matter and releases the debris into the dryer airflow to be relocated into the dryer lint filter.

Another object of the present invention is to provide a laundry debris removal device that has overlay substrates on an exterior surface, the overlay substrate having a higher coefficient of friction than both the substrate base fabric and the articles of clothing in the dryer, in order to remove the excessive lint and other laundry debris.

It is another object of the present invention to provide a method of using the laundry debris removal device, with possible accessories, in combination with a dryer machine in order to reduce the amount of lint, hair, fur, dirt, and other particles in a load of finished laundry.

### SUMMARY

A sheet-like base material having indicia or overlay structure printed on exterior surfaces of the base material is provided. The indicia is printed with a tackified ink. Without intending to be limited to theory, when the laundry debris removal device is placed in a heated air laundry dryer with items to be dried, it tumbles with the items to be dried and the tackified ink captures of dislodges laundry debris, such as hair, fur, lint or other particulates, from the items being dried and releases the laundry debris into the airflow for capture by the dryer filter. The tackified ink may have a silicone, rubber, or polyvinyl chloride (PVC) component that lends the tack properties to the ink. Heated air in the dryer will generally increase the tackiness of the ink and increase its ability to capture laundry debris from the items being dried.

### BRIEF DESCRIPTION OF THE DRAWINGS

FIG. 1 is a perspective view of one variant of the laundry debris removal device in accordance with the present invention.

FIG. 2 is a cross-sectional view taken along line 2-2 of FIG. 1.

FIG. 3 is a perspective view of a second variant of the laundry debris removal device in accordance with the present invention.

FIG. 4 is a cross-sectional view taken along line 4-4 of FIG. 3.

FIG. 5 is a partial cross-sectional side elevational view of a third variant of the laundry debris removal device in accordance with the present invention.

FIG. 6 is a diagrammatic view illustrating the laundry debris removal device in a laundry dryer.

FIG. 7 is a flowchart diagram illustrating the preparation and execution of a screen printing process for printing the indicia onto the base substrate.

FIG. 8 is a flowchart diagram illustrating the method of using the laundry debris removal device in combination with a dryer.

### DETAILED DESCRIPTION OF THE PREFERRED EMBODIMENTS

For purposes of clarity, the following terms used in this patent application will have the following meanings:

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the order discussed or illustrated, unless specifically identified as an order of performance. It is also to be understood that additional or alternative steps may be employed.

When an element or layer is referred to as being “on,” “engaged,” “connected,” or “coupled” to or with another element, it may be directly on, engaged, connected or coupled to the other element or layer, or intervening elements or layers may be present. In contrast, when an element is referred to as being “directly on,” “directly engaged to,” “directly connected to,” or “directly coupled to” or with another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

“Substantially” is intended to mean a quantity, property, or value that is present to a great or significant extent and less than, more than or equal to totally. For example, substantially vertical may bean less than greater than or equal to completely vertical.

“About” is intended to mean a quantity, property, or value that is present at ±10%. Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range, including endpoints given for the ranges.

The use of the terms “a” and “an” and “the” and similar referents in the context of describing the invention are to be construed to cover both the singular and the plural, unless otherwise indicated herein or clearly contradicted by context. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Recitation of ranges of values herein are merely intended to serve as a shorthand method of referring individually to each separate value falling within the recited range, unless otherwise indicated herein, and each separate value is incorporated into the specification as if it were individually recited herein.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

The use of the term “abrade” in the context of describing the invention shall be understood to mean the process in which one material rubs or comes into contact with a foreign article or item for the purpose of removing debris, such as lint, hair, fur, dirt, or other particulate matter, from the foreign fabric.

As described herein, the terms “fabric,” “cloth,” and “textile” shall be used interchangeably. One of skill in the textile art would understand that these terms refer to a material that has individual yarns and fibers that have been manufactured together, via one of weaving, knitting, knotting, braiding, tufting, or some other bonding process. These materials can utilize synthetic or natural fibers in their construction.

Furthermore, the use of the term “release” or similar referents in the context of describing the invention will be construed to mean that an item has been set free of physical restraint, entanglement with another structure, or let go from bondage with a foreign body, or as otherwise understood in the mechanical art.

This detailed description of exemplary embodiments makes reference to the accompanying drawings, which show exemplary embodiments by way of illustration. While these exemplary embodiments are described in sufficient detail to enable those skilled in the art to practice the disclosure, it should be understood that other embodiments may be realized and that logical changes and adaptations in design and construction may be made in accordance with this disclosure and the teachings herein without departing from the spirit and scope of the disclosure. Thus, the detailed description herein is presented for purposes of illustration only and not of limitation.

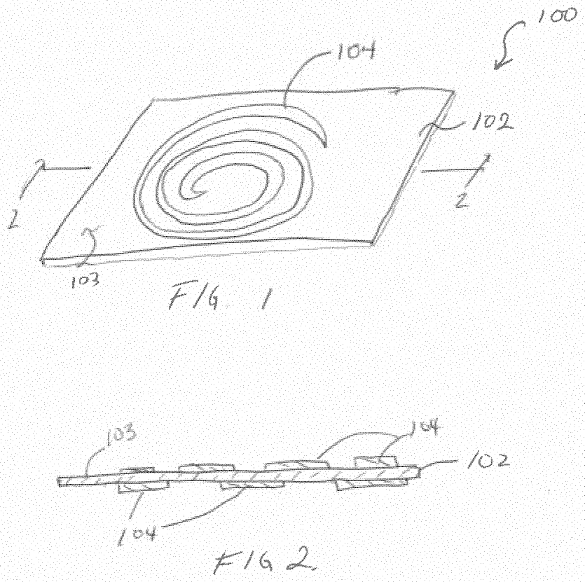

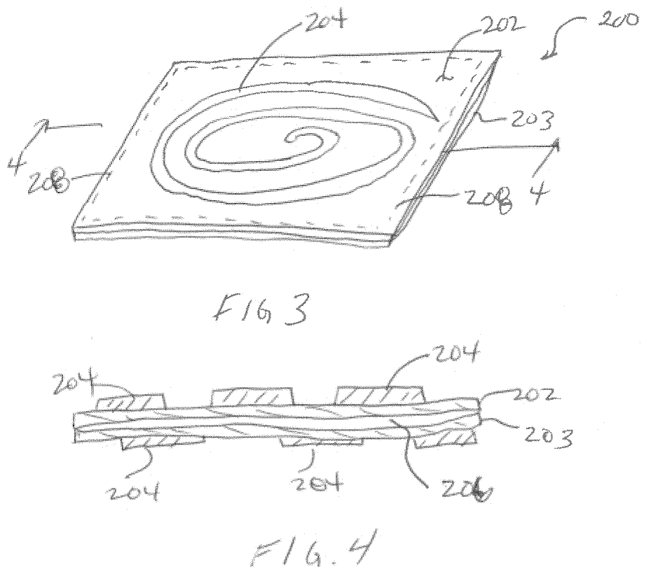

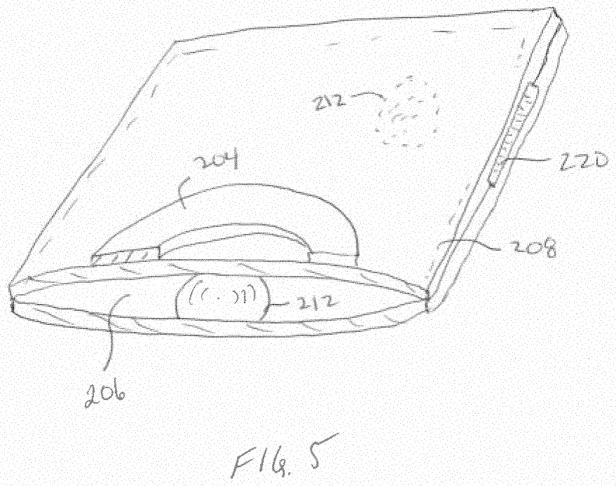

Turning now to the accompanying Figures in which exemplary embodiments of the present invention are illustrated and common reference numerals denote common feature. In accordance with the present invention, FIG. 1 illustrates a laundry debris removal device 100, which comprises the use of a generally planar fabric substrate material 102 which may have one or more layers of fabric substrate material 102, as shown in FIGS. 3 and 4 respectively. The laundry debris removal device 100 may, on opposing exterior surfaces 103 of the substrate material 102, have at least one of a plurality of overlay substrates 104 disposed on an exterior surface 103, the overlay substrates 104, which may be a textual and/or graphical indicia, is made of a tacky heat activated material that has a raised profile relative to the substrate material 102 as shown in FIG. 2. The raised profile of the fabric substrate material 102 effectively increases the surface area laundry debris removal device 100 that is available to interact with items in the laundry dryer.

The fabric substrate material 102 may consist of a fabric material capable of maintaining its structural integrity and dimensional integrity when exposed to temperatures and moisture levels commonly found in residential or commercial laundry dryers. Typical laundry dryer temperatures range from about 110-120° Fahrenheit (about 43-49° Centigrade) on a low temperature setting to about 140-150° Fahrenheit (about 60-66° Centigrade) on a high temperature setting, when measured at the hot air inlet within the dryer drum and without clothes in the dryer.

The fabric substrate material 102 can be produce by any one of the following methods: weaving, knitting, or a non-woven fabric formation technique. If the fabric substrate material 102 is woven, the woven material may have a warp density of about 50 to 250 yarns per inch. Durable weave patterns that could be used to produce the substrate material include plain weave, twill weave, and basket weave patterns. On the other hand, if the fabric substrate material 102 is a knitted fabric, the knitted material may have a knit density between about 2000 to 2500 wales per square inch. The fabric substrate material 102 can be made from durable warp knit or weft knit patterns, including jersey knits, rib knits, and interlocking knit patterns. Furthermore, the fabric substrate material 102 can comprise a mesh pattern to maximize the transfer of heat, air porosity, and structural stability of the fabric.

Each layer of fabric substrate material 102 may have a thickness of about 0.20-0.40 mm. The fabric substrate material 102 preferably has a weight of between about 160-300 g/m², and is preferably between about 160-180 g/m² and may be increased to about 280-300 g/m². It will be appreciated by those skilled in the art that by increasing the weight of the fabric substrate material 102, either the fabric material, fabric density or the material thickness, or combinations thereof, will change. For example, knit polyester materials having a knit density between approximately 2000 to 2500 wales per square inch, with a fabric weight of about 160-180 g/m² has a thickness of each fabric substrate material 102 layer of about 0.20-0.40 mm. Increasing the fabric weight to about 280-300 g/m² increases the thickness of each layer of fabric substrate material 102 by about 0.10-0.25 mm.

Preferred materials for the fabric substrate material 102 are synthetic materials, such as polyester, polyamides (i.e. nylon), polyacrylic, and triacetate. Organic fabrics, such as cotton, have been found to decompose in the temperature and moisture conditions of laundry dryers and are not typically sufficiently durable to withstand high numbers of use cycles of the present invention. Blends of organic and synthetic materials, such as cellulose acetate, may, however, be used with the present invention.

The tacky heat-activated material employed to make the indicia or overlay structure 104 on the fabric substrate material 102 is a heat-activated ink printed on the exterior surfaces 103 of the fabric substrate material 102. Multiple methods of applying the indicia or overlay structure 104 to the fabric substrate material 102 are contemplated, with a preference for screen printing. The heat activated ink employed for the indicia or overlay structure 104 is preferably a rubber, polyvinyl chloride and/or silicone based ink. For example, polyvinyl chloride (PVC) based inks suitable for use in the present invention include PVC particles suspended in a plasticizing emulsion, like diethylhexyl phthalate (DEHP) or dioctyl phthalate (DOP). Such types of PVC based inks are known in the art as “plastisol” ink. Plastisol inks typically must be heat cured, which may be done by heat curing at between about 100 to about 180 degrees Celsius. Plastisol inks tend not to be absorbed or adsorbed into the fabric substrate material 102, but sit on top of the substrate fabric material giving a raised profile on the fabric substrate material 102 when fully cured. It should be understood that, depending on what ink is utilized, the ink must be cured by either applying heat or by allowing the ink to dry over a period of time.

In addition to using a heat activated ink and a plasticizing agent, the tacky heat-activated material also will include polypropylene glycol, isobutyl methacrylate, and an antifoaming agent during the mixing step. Once thoroughly mixed, the tacky heat-activated material is applied to the fabric substrate material 102 via a screen printing process. It should be understood that the tacky heat-activated material can be applied to the fabric substrate material 102 in a manual or an automatic manner and will cover between fifty (50) percent and eighty (80) percent of the exterior surface of the fabric substrate material 102. For the instant invention, the preferred method of application is manually, in order to ensure consistent application and product quality.

The tacky heat-activated material of the indicia or overlay substrate 104 has a coefficient of friction that is relatively higher than the base material 102 and also relatively higher than the materials employed to make clothing and other household items typically used in residential and commercial dryers. By having a relatively higher coefficient of friction, the indicia or overlay substrate 104, laundry debris, such as lint, pet hair, dust or the like, is dislodged from the clothing or other drying articles by the indicia or overlay substrate 104 interacting with the articles being dried and releases the laundry debris into the dryer airflow for capture on the dryer lint filter.

In an alternative embodiment of the laundry debris removal device 200, and as shown in FIGS. 3 and 4, the invention includes a pocket 206 between at least two fabric substrate material layers 202, 203 joined by a seam 208. Again an indicia or overlay structure 204 is provided on an exterior surface of each of the at least two fabric substrate material layers 202, 203. At least one of a plurality of polymer spheres 212 are placed within the pocket prior to closing the seam 208. The polymer spheres 212 increase the agitation of items within the dryer and contact between the items and the laundry debris removal device 200, to increase laundry debris removal and drying efficiency. The polymer spheres 212 may be made of polyester, polyurethane, and ethyl-vinyl acetate (EVA) and have a density ranging from 0.15 to 0.45 grams per cubic centimeter. Furthermore, the polymer spheres 212 may have a weight ranging from about 16 grams to about 220 grams, have a diameter between about 6 cm to 8 cm and a volume ranging from about 110 to about 270 cubic centimeters.

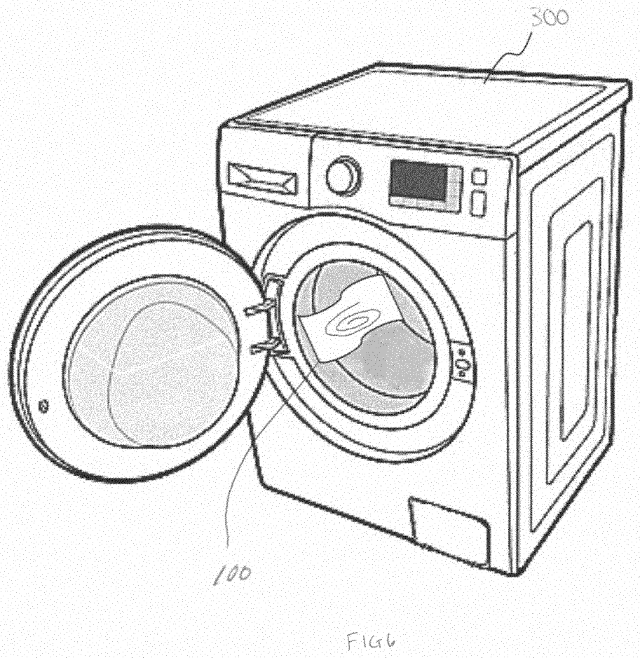

A further alternative embodiment of the laundry debris removal device 200 is depicted in FIG. 5. According to this alternative embodiment, the laundry debris removal device 200 has at least one opening 220 passing through at least one of the fabric substrate material layers 202, 203 and communicating with the pocket 206. The at least one opening 220 has a size configured to allow the polymer spheres 212 to be inserted into and through the at least one opening 220 and into the pocket 206. The at least one opening 220 may also include a closure 222 that permits a user to open and close the at least one opening 220 to access the pocket 206 and polymer spheres 212. Closure 222 may be a zipper, a hook-and-loop material, a snap, a button, a hook and eye, combinations thereof, or other similar closure devices as are known in the art.

FIG. 6 is a diagram of a typical residential laundry dryer 300 illustrating placement of the inventive laundry debris removal device 100 into the drying drum of the laundry dryer 300.

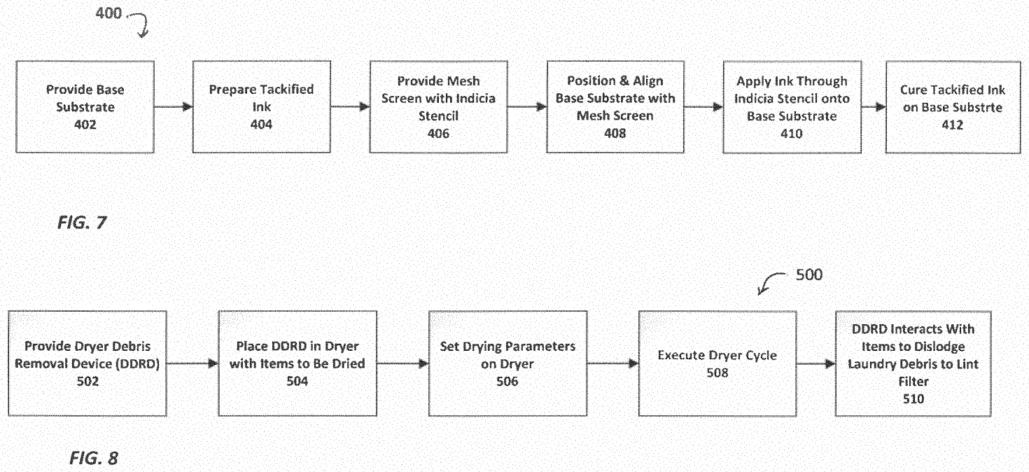

FIG. 7 is a flow chart depicting a screen printing method 400 for making the inventive laundry debris removal device 100, 200 in accordance with the method of the present invention. Method 400 includes the steps of providing the base substrate 402, preparing the tackified ink 404, providing a mesh screen suitable for screen printing with a stencil corresponding to the desired indicia 406, positioning and aligning the base substrate with the mesh screen 408, applying the tackified ink through the indicia stencil and onto the base substrate 410 and curing the tackified ink on the base substrate 412. Those skilled in the art will appreciate that steps 402, 404 and 406 may be performed in any order and the method 400 is not limited to the order of steps as set forth above or as depicted in FIG. 7.

Finally, FIG. 8 is a flow chart depicting a method 500 of using the laundry debris removal device 100, 200 in accordance with a method of use of the present invention. Method 500 includes the steps of providing a the dryer debris removal device 502, placing the dryer debris removal device in a dryer with items to be dried 504, setting desired drying parameters on the dryer 506, executing the dryer cycle 508 and allowing the dryer debris removal device to interact with the items to dislodge debris from the items 510, into the dryer airflow and onto the lint filter of the dryer.

While the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

1. A laundry debris removal device, comprising: a sheet-like base substrate and an indicia disposed upon at least one surface of the sheet-like base substrate, the indicia having a heat-activated tackiness operable to capture laundry debris from articles in a laundry dryer.

2. A method of screen printing comprising the steps of fabricating a base substrate, obtaining a heat reactive solvent ink and mixing the heat reactive solvent ink with a plastisol pigment and a plasticizing agent to create a pigment composition, preparing a screen printing mesh screen with a stencil to produce a pre-selected image for the pigment composition, positioning the base substrate in under the screen printing mesh screen, applying the pigment composition to the base substrate via a squeegee or pump to create the pre-selected image, and transferring the base substrate to an oven and curing the re-selected image of pigment composition on the base substrate, wherein the method is used to produce the laundry debris removal device of claim 1.

3. The laundry debris removal device of claim 1, where the sheet-like base substrate is a woven, knitted, or non-woven fabric.

4. The laundry debris removal device of claim 3, wherein the sheet-like base substrate has a layer thickness ranging from 0.20 to 0.40 mm.

5. The laundry debris removal device of claim 3, wherein the sheet-like base substrate has a perimeter seam located along a plurality of edges of the sheet-like base substrate to prevent fraying during use.

6. The laundry removal device of claim 5, wherein the sheet-like base substrate is folded over about an axis in the width direction and the perimeter seam is located on the plurality of edges opposite the fold of the sheet-like base substrate.

7. The laundry removal device of claim 1, where the indicia comprises a heat activated ink and a plasticizing agent.

8. The laundry removal device of claim 7, wherein the heat activated ink can be one of rubber, silicone, or polyvinyl chloride (PVC) based ink.

9. A laundry debris removal device for use in a clothing dryer, comprising at least one fabric base substrate and an overlay structure adhered to at least one exterior surface of the fabric base substrate, the fabric base substrate being one of a knitted, woven, or nonwoven fabric construction, and the overlay structure has a heat-activated tacky finish that is configured to interact with and dislodge debris from items being dried and releasing the debris into an airflow stream and onto a lint filter of the clothing dryer.

10. The laundry debris removal device of claim 9, wherein the overlay structure further comprises a heat activated ink and a plasticizing agent, with the heat activated ink being one of rubber, silicone, or polyvinyl chloride (PVC) and the plasticizing agent is either diethylhexyl phthalate (DEHP) or dioctyl phthalate (DOP).

11. The laundry debris removal device of claim 9, wherein the at least one fabric base substrate is formed as a pocket by using multiple layers and further comprises a perimeter stitch to prevent fraying during use.

12. The laundry debris removal device of claim 11, comprising a plurality of polymer spheres located within the pocket.

13. The laundry debris removal device of claim 9, the at least one fabric base structure is folded along a horizontal axis, the at least one fabric base structure further comprising a plurality of edges, wherein the plurality of edges are aligned with a corresponding edge when the at least one fabric base structure is folded.

14. The laundry debris removal device of claim 13, wherein the at least one fabric base structure comprises a perimeter seal.

15. The laundry debris removal device of claim 9, wherein the overlay structure creates an aesthetic design or indicia that covers a majority of an exterior surface of the at least one fabric base substrate.

16. The laundry debris removal device of claim 15, wherein the overlay structure covers between 50 to 80% of the exterior surface of the at least one fabric base substrate.

17. A method of using a dryer debris removal device to capture excess lint and laundry debris, comprising the steps of
A. Placing the dryer debris removal device, comprising a fabric base and a tacky overlay, into a clothing dryer with a load of washed clothing;
B. Setting the clothing dryer's machine parameters to coincide with a temperature profile of the dryer debris removal device; and
C. Executing the clothing dryer's drying cycle, wherein the tacky fabric overlay of the dryer debris device is heated and captures laundry debris and wherein the tacky fabric overlay releases the laundry debris into a clothing dryer lint filter.

18. The method of use of claim 17, where the fabric base is a woven, knitted, or non-woven fabric, and the fabric base is one of polyester, polyamides, nylon, polyacrylic, or triacetate.

19. The method of use of claim 17, wherein the tacky fabric overlay further comprises a heat reactive ink and a plasticizing agent, with the heat reactive ink being one of rubber, silicone, or polyvinyl chloride (PVC) and the plasticizing agent is either diethylhexyl phthalate (DEHP) or dioctyl phthalate (DOP).

20. The method of use of claim 17, wherein the dryer debris removal device further comprises at least one polymer sphere enclosed within the dryer debris removal device.
